(19) United States
(12) Patent Application Publication
(10) Pub. No.: US 2017/0083668 A1
(43) Pub. Date: Mar. 23, 2017

(54) METHOD AND APPARATUS PROVIDING AN ONLINE DIAGNOSTIC ASSISTANT TOOL

(71) Applicant: INTERNATIONAL BUSINESS MACHINES CORPORATION, Armonk, NY (US)

(72) Inventors: Lee M. SURPRENANT, Research Triangle Park, NC (US); Jacob D. EISINGER, Austin, TX (US); Richard M. ROGERS, Research Triangle Park, NC (US)

(73) Assignee: INTERNATIONAL BUSINESS MACHINES CORPORATION, Armonk, NY (US)

(21) Appl. No.: 15/371,042

(22) Filed: Dec. 6, 2016

Related U.S. Application Data
(63) Continuation-in-part of application No. 13/355,041, filed on Jan. 20, 2012.

(51) Int. Cl. G06F 19/00

(52) U.S. Cl. CPC G06F 19/322

(57) ABSTRACT

Information including data indicative of a problem concern is determined by changing an active/past state of the data from an active state to a past state based on a time of an update (e.g., time of an update of a diagnosis, when a file may be updated) indicative of a resolution of the problem concern. When a most recent entry in the data exceeds a duration range for the problem concern as determined by a knowledge base, the active/past state of the data is changed from the active state to the past state. Further, it determines whether the problem concern is correlated with a treatment. When the correlated treatment is being taken by a subject, changing the active/past state of the data from the active state to the past state so as to provide diagnostic assistant tool to a clinician for a meeting with the subject.

This is a Continuation-In-Part application of U.S. application Ser. No. 13/355,041, filed Jan. 20, 2012, in the U.S. Patent and Trademark Office, the disclosure of which is incorporated herein by reference in its entirety.

### BACKGROUND

Field

Aspects of the example embodiments are directed to identifying relevant information from a large set of medical records of a patient and creating patient medical summary, and more specifically, to a method and non-transitory article of manufacture of determining active and past medical information for correlation with a treatment.

Related Art

A related art model for packaging and sharing patient data of medical history is via a shared or federated document repository, populated by healthcare organizations with standardized documents representing patient data from a given encounter. Healthcare organizations may be required to do this as a component of their demonstration of meaningful use of electronic medical record systems.

Patient medical history has a tendency to include repeating events. For example, medical ailments may appear to be cured or resolved, but may then return thereafter. For example but not by way of limitation, allergies may be considered a repeating medical event. Accordingly, a related art health record summary is generated by including previous bits of information related to the patient medical information. This health record summary including the patient medical information can be digitized and shared across organizations by medical professionals, and applied for diagnosis and treatment of patients that encounter different organizations (e.g., healthcare providers). There is a related art need to determine which subset or subsets of the digitized and shared patient medical information to share. More specifically, there is a related art need to determine which information from a potentially large set of medical records of a given patient must be shared to create a patient's medical summary.

Related art medical history record management includes diagnosis and treatment information of medical problem concerns. Medical Problems or problem concerns can be expressed through a series of observations ranging from patient complaint to symptoms to diagnoses (e.g., symptom=cough, finding=rusty-colored sputum, diagnosis=pneumonia). Related art Electronic Health Record (EHR) systems includes active problem concerns due to their high importance in all patient summaries. However, inclusion of past problem concerns is also of high importance, particularly with respect to chronic problem concerns in remission, or possible relevant information for future treatment. Thus, in the related art, there is an unmet need to determine, from a given set of medical records, the patient's active problem concerns (e.g. chronic gout) and past problem concerns, and to determine the connectedness or degree of relevance with other different medical problem concerns in the medical records and with those active medical problem concerns, and in this way, a diagnostic assistance tool that determines past problem concerns, and provide information about other connected but different medical problem concerns with treatment information can be provided to a clinician for a more efficient diagnosis during a meeting with the patient.

### BRIEF SUMMARY

Aspects of the example embodiments relate to a method of determining medical information including medical data of a patient indicative of a medical condition or problem concern. The method comprises changing a state of the data from an active state to a past state based on a time of an update (e.g., time of an update of a diagnosis, when a file may be updated) indicative of a resolution of the problem concern, when a most recent entry in the data exceeds a duration range for the problem concern as determined by a knowledge base, changing the active/past state of the data from the active state to the past state, and determining whether the problem concern is correlated with a treatment, and when the correlated treatment is being taken by a subject, changing the active/past state of the data from the active state to the past state.

Additional aspects of the example embodiments relate to a non-transitory computer readable medium configured to store instructions for determining information including data indicative of a problem concern. The instructions include changing an active/past state of the data from an active state to a past state based on a time (e.g., time of an update of a diagnosis, when a file may be updated) indicative of a resolution of the problem concern, when a most recent entry in the data exceeds a duration range for the problem concern as determined by a knowledge base, changing the active/past state of the data from the active state to the past state, and determining whether the problem concern is correlated with a treatment, and when the correlated treatment is being taken by a subject, changing the active/past state of the data from the active state to the past state.

Further aspects of the example embodiments relate to an apparatus for determining information including data indicative of a problem concern, the apparatus including a processor and a memory. The apparatus includes a changer that changes an active/past state of the data from an active state to a past state based on a time of an update (e.g., time of an update of a diagnosis, when a file may be updated) indicative of a resolution of the problem concern, and when a most recent entry in the data exceeds a duration range for the problem concern as determined by a knowledge base, changes the active/past state of the data from the active state to the past state. The apparatus also includes a determiner that determines whether the problem concern is correlated with a treatment, and when the correlated treatment is being taken by a subject, changes the active/past state of the data from the active state to the past state. In other words, the present application provides a diagnostic assistant tool to a physician for a scheduled meeting with a patient.

It is to be understood that both the foregoing and the following descriptions are exemplary and explanatory only and are not intended to limit the claimed embodiments or application thereof in any manner whatsoever.

### BRIEF DESCRIPTION OF THE SEVERAL VIEWS OF THE DRAWINGS

The accompanying drawings, which are incorporated in and constitute a part of this specification exemplify the example embodiments and, together with the description, serve to explain and illustrate principles of the inventive techniques. More specifically:

FIG. 1 illustrates a first example process, related to grouping of concern entries according to an example embodiment;

FIG. 2 illustrates a second example process related to active concern entries according to an example embodiment;

FIG. 3 illustrates a second example process related to active concern entries according to an example embodiment;

FIG. 4 illustrates an example block diagram of a computer/server system upon which an example embodiment may be implemented;

FIG. 5 illustrates an example network environment for operation of the processes; and

FIG. 6 illustrates an example patient record of a hypothetical patient John Doe being analyzed by the processes according to an example embodiment.

### DETAILED DESCRIPTION OF EXAMPLE EMBODIMENTS

In the following detailed description, reference will be made to the accompanying drawings, in which identical functional elements are designated with like numerals. The aforementioned accompanying drawings show by way of illustration, and not by way of limitation, specific embodiments and implementations. These implementations are described in sufficient detail to enable those skilled in the art to practice the example embodiments and it is to be understood that other implementations may be utilized and that structural changes and/or substitutions of various elements may be made without departing from the scope and spirit of example embodiments. The following detailed description is, therefore, not to be construed in a limited sense. Additionally, the example embodiments as described may be implemented in the form of software running on a general-purpose computer, in the form of a specialized hardware, or combination of software and hardware.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The example embodiments are directed to determining, from a collection of documents, a list of active and certain past problem concerns that should be considered by a clinician when treating a patient. Relevant problem concern data is captured and analyzed with respect to external data sources, to provide diagnosis guidance, especially about treatment information, for a clinician with respect to the contents of the list of active and certain past problem concerns. Accordingly, accurate, current and relevant data not just from active problem concerns in the patient's data but also from certain past problem concern such as chronic disease with respect to a patient's medical condition or problem can thus be provided in an efficient manner, e.g. in a summary displayed in a display device that gives a clinician a single view during a meeting with the patient. For example, but not by way of limitation, an accurate active problem concern list provides clinical decision support. More specifically, example embodiments include aggregated problem concern data from relevant documents, and incorporate additional metadata (e.g., flags), so that a clinician can quickly review and comprehend relevant active problem concern data for a patient encounter.

In the example embodiments, medical documents or other patient history with structured or unstructured records (e.g., problem concern entries) are provided. One or more related art ‘terminology’ sets that are well-known in the art may be used for the problem concern entries, such as SNOMED CT (Systemized Nomenclature of Medicine—Clinical Terms), or ICD-9 or ICD-10 (International Classification of Diseases). For example, but not by way of limitation, SNOMED CT is an ontology that classifies clinical terms into groups. However, the foregoing sets are intended to be exemplary in nature. One of ordinary skill in the art would understand that another coding system, or no coding system at all, could be substituted therefor without departing from the scope of the inventive concept.

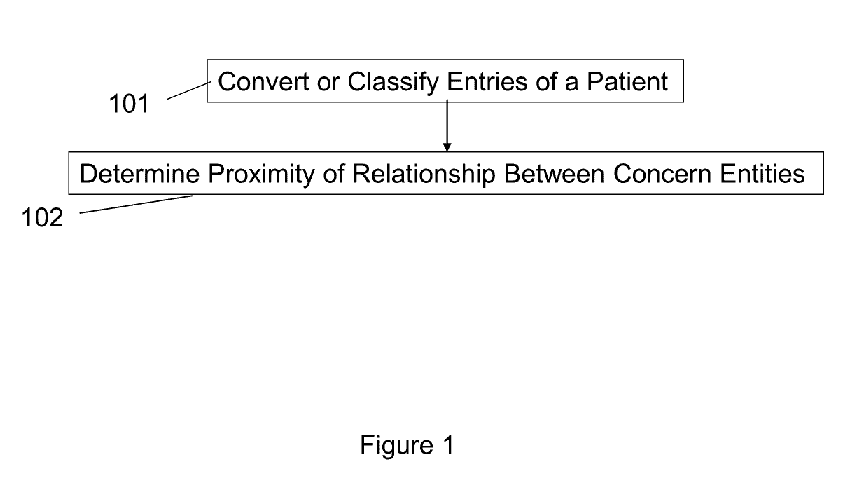

FIG. 1 illustrates an example process. In process step 101, concern data entries of a patient may be converted via one of the above-noted terminology sets (e.g., SNOMED CT). In process step 102, a determination is made as to the proximity of relationship between the concern different data entries, and whether the concern different data entries can be grouped into a same medical problem concern of the patient. The foregoing example process can be implemented by use of ontological tools that operate over the SNOMED knowledge base. For example, but not by way of limitation, direct relationships (e.g., synonym, is-a, has-a, etc.) relationships may be employed. Alternatively, ‘proximity’ on the hierarchical knowledge base (e.g., both concern entries extend from a common high-level disease classification) may also be employed. The foregoing example process may be configured based on the configuration of the system, or the specific problem concerns provided for the given instance of a summarization request. The example process as explained above and illustrated in FIG. 1 provides a proximity of the relationship between concern entries, as well as a determination with respect to possible common grouping of the concern entries. As disclosed above with respect to the related art, problem concerns can be grouped into active problem concerns and past problem concerns. The example embodiments incorporate additional metadata (e.g., flags) into the active problem concerns and past problem concerns.

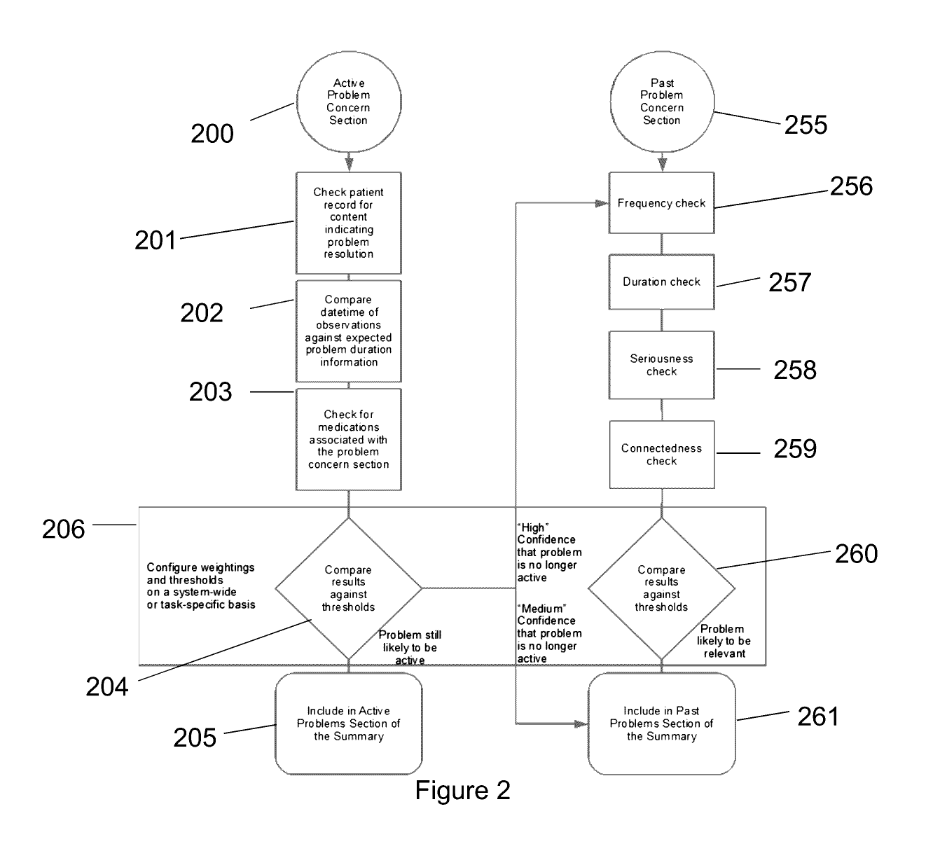

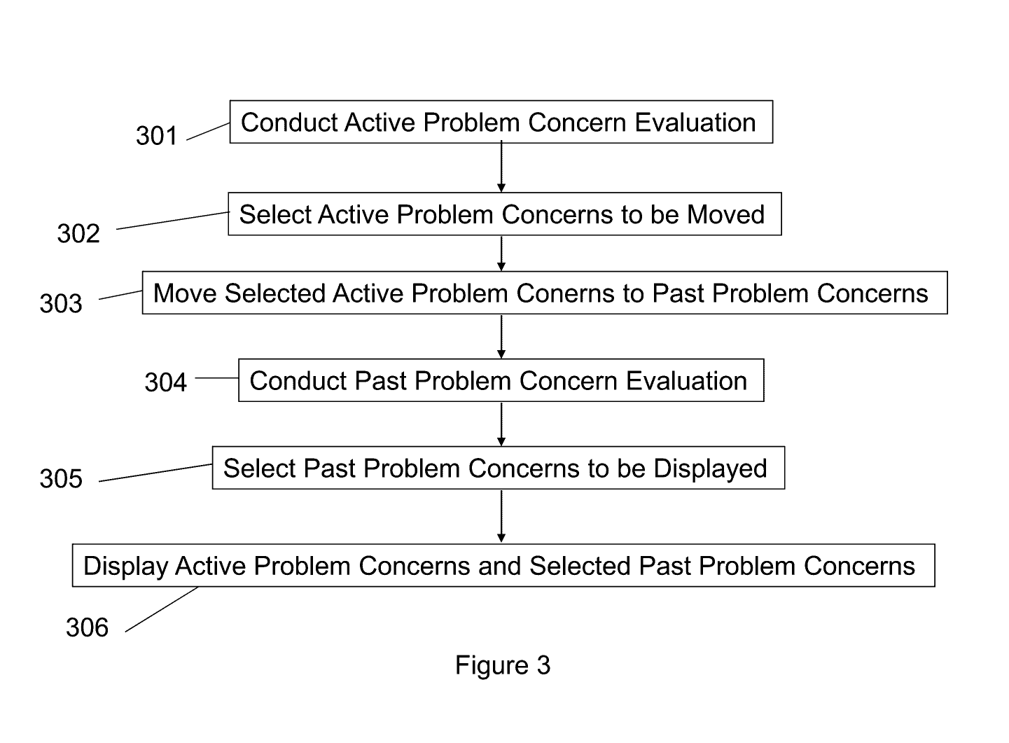

FIG. 2 illustrates an example process. An active problem concern section 200 and a past problem concern section 255 are provided. The active problem concern section 200 is for incorporating metadata into the active problem concerns. The example process of FIG. 3 is performed for each active problem concern group in a patient's history.

In item 201, a search of the patient record is performed to determine whether content exists that provides an indication that the problem concern has been resolved. For example, but not by way of limitation, a search of the data is performed for clinical statements that indicate the problem concern is no longer active, or later documents that demonstrate movement of that the concern from the active group to the past group.

According to one example embodiment of item 201, when a timestamp of an indication a resolution is later than a timestamp that is indicative of the latest problem concern entry in the group, the problem concern is characterized as having been resolved, and thus moved from the active group to the past group that includes a list of past problem concerns to consider for inclusion. Treatment of the past problem concern group is discussed in greater detail further below.

Additionally, the example embodiment of FIG. 2 may also incorporate an account confidence level with respect to the determination that the problem concern is no longer considered active. The confidence level may be generated by a health care professional (e.g., clinician) who assesses the situation and enters the confidence level. For example, a chronic problem concern (e.g., diabetes patient not taking a certain type of insulin, possibly due to a replacement drug on the market) or a recurring problem concern have a difference confidence level than other problem concerns.

In item 202, a clinical knowledge base is referenced with respect to a datestamp (i.e., datetime) to determine an indicator as to whether the maximum reasonable duration of the given problem concern has been passed (i.e., problem concern duration information). For example, the clinical knowledge base may include (but is not limited to) an internal or external knowledge base such as a national disease registry. For chronic problem concerns, such knowledge bases would characterize the expected duration as spanning the lifetime of the patient. Accordingly, such chronic problem concerns are included in the active problem concerns section, and may not be moved to the past problem concerns grouping.

When it is determined that a most recent problem concern entry of this problem concern section is not within the duration range, of the problem concern, the problem concern is moved into the list of past problem concern group. In other words, the most recent problem concern as an active problem concern is determined by a determiner as a past problem concern. Treatment of the past problem concern group is discussed in greater detail further below.

In item 203, medication records are queried to determine the existence of medications that are associated with the problem concern. Such medication records may be found in the same documents as the problem concern entries. The medications (e.g., prescriptions) may be repeating or current. Such medication information may be kept up-to-date more frequently than problem concern lists. A reason for the difference in the frequency of update includes potential drug-to-drug interactions, and the necessity for patients to order refills for controlled substances.

Where no explicit linkage is demonstrated between the medication and the problem concern, a correlation may be inferred. The inferred linkage is indicated by confidence levels and evidence. Such an inference may optionally be generated by co-location and/or external clinical knowledge.

Additionally, in item 203, a determination may be made as to whether a patient continues to take the medication that most closely corresponds to the problem concern that is being evaluated. If the patient does not continue to take the medication corresponding to the problem concern, an indication may be provided that the problem concern is “possibly resolved”. However, the problem concern continues to be maintained in the active problem concerns grouping.

Once the foregoing evaluations have been performed, determinations are made as shown in item 206 to change a problem concern from active to past, and to determine a confidence level of the problem concern status. Based on these determinations in item 206, the problem concern may be displayed in the summary at the Active Problem Concerns section 205 or the Past Problem Concerns section 261, or not displayed at all. Further details of item 206 are disclosed as follows.

As shown in item 204, the results of items 201, 202 and 203 are compared against thresholds. This may be done on a systematic level, or on a task-by-task level. Based on the comparison, it is determined whether the problem concern is likely to be active. If so, the problem concern is maintained in the active problem concern section at item 205.

If it is determined that the problem concern is not likely to be active, a determination is made regarding the confidence level, as explained above. The confidence level is determined at or above a threshold, (e.g., “high” confidence that a problem concern is no longer active) or below the threshold (e.g., “medium” confidence that a problem concern is no longer active).

If the confidence level is “medium”, the past problem concern is listed in a “past problem concerns” section of the summary as shown in item 261. If the confidence level is “high”, the past problem concern section 300 performs processing as explained below.

Accordingly, metadata of the active problem concerns based on the example process as explained above and illustrated in the active problem concern section 200. Thus, the active history information can be processed, and entries moved or flagged as necessary, to provide further decision support (e.g., accurate, current and relevant) for the clinician.

The foregoing method includes example metadata that may be analyzed to determine whether a problem concern is active or past. However, other metadata may be substituted therefor, and/or or added thereto, without departing from the scope of the inventive concept.

The past problem concern section 255 incorporates the metadata into the past problem concerns. For example, but not by way of limitation, the past problem concerns are scored with one or more algorithms. The overall score of one of the problem concerns may be based on the combination of feature scores such as the last document which showed the problem concern as active (recency), the number of times the concern appears in the medical history (frequency), the length of time the patient has dealt with this as an active concern (duration), the severity of the concern (seriousness), and the relevance to the reason of the current visit (connectedness). Each of these features would be scored independently according to a custom numerical axis (details for each of these examples appear below) and the overall score of the problem concern would be based on the combination of these individual values. In a simplistic example, such a score could be computed by normalizing the axis of each individual feature score and then taking the average. Alternatively, each feature could have its own configured weighting that would control how much it influences the overall score of the problem concern. In one embodiment, the individual weights for each feature area could be configured by the end user in a context-specific manner. For example, in the primary care setting, the frequency and duration scores may carry more weight as they represent the problem concerns that the patient has likely spent the most time dealing with, whereas in the acute/emergency setting, perhaps the recency and seriousness features may carry more weight. In one embodiment, the weighting of the individual features is determined in a context-specific manner through the use of machine learning techniques that can infer feature weightings from previously created medical summary documents by determining the weightings that would provide results as similar as possible to the training set of summaries. The purpose of the scoring is to determine which past problem concerns (if any) should be included in a summary displayed by a display device. Below a given threshold, a past problem concern may not be included in the summary displayed by a display device. Moreover, a separate view of past problem concerns may be included in the summary section.

In item 256, each past problem concern in the past problem concern group is scored based on frequency of problem concern entries in the past problem concern group. For example, but not by way of limitation, this may include a number of discrete times that the patient suffered from this problem concern, and/or how many times the patient was treated for the problem concern.

In item 257, each past problem concern in the group is scored based on duration. For example, but not by way of limitation, the total amount of time spent dealing with the given problem concern (from likely onset until likely resolution) across all discrete instances of the concern.

In item 258, each past problem concern is scored based on severity and/or seriousness. For example, but not by way of limitation, this may be scored as follows:
High: Life threatening or potential to cause permanent injury
Moderate: Noticeable adverse consequences but unlikely to threaten life or cause permanent injury
Low: Potential adverse consequences but unlikely to substantially affect subject's situation/quality of life.

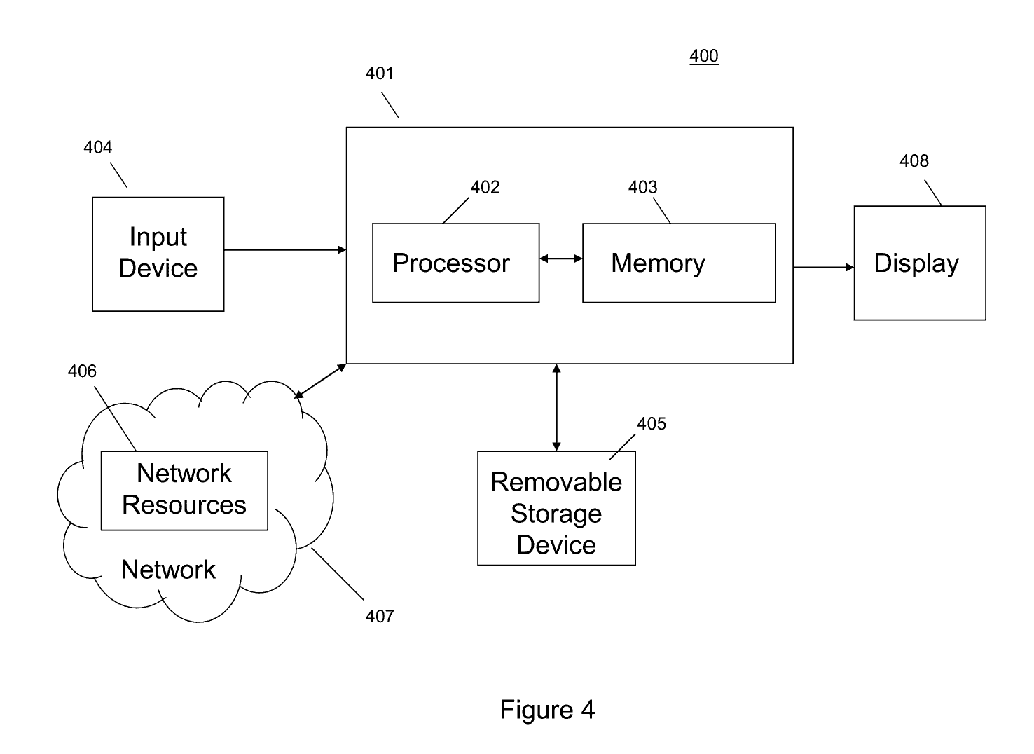

In item 259, each past problem concern is scored according to its connectedness to other problem concerns and/or to the reason for the current visit. For example, but not by way of limitation, the importance of a problem concern may correlate to the number of closely-related problem concerns. In one embodiment, connectedness may be computed via a knowledge graph that contains many different disease concepts. Such a knowledge graph could be constructed from existing ontological terminologies like SNOMED CT or assembled via the bespoke processing of medical literature. From within the graph, two problem concerns could be said to be connected based on their distance from one another in the graph. For example, concerns could be connected if they relate to the same body structure or even if they share a common symptom or treatment/drug. A related art search algorithm as illustrated in FIG. 4 may be used.

As shown in item 260, the foregoing checks at items 256, 257, 258, 259 are compared against thresholds at item 260. If it is determined that the problem concern is likely to be relevant (e.g., above a weighted threshold), the past problem concern is included in the summary at the Past Problem Concerns Section as shown in item 261. Thresholds may be manually configured either a priori or even adjusted on the fly by the consumer of the medical summary. For example, if a treating physician wanted only the most highly relevant data in the summary, the threshold could be set to a high value so that only frequent/serious/connected concerns are shown. If they had more time and wanted to see a more complete summary, they could set a lower threshold instead. In one embodiment, the threshold for the problem concern entries to appear in the summary is determined in a context-specific manner through the use of machine learning techniques that can infer threshold(s) from previously created medical summary documents by determining the threshold(s) that would provide results as similar as possible to the training set of summaries.

Accordingly, in view of the foregoing example process as explained above, the past history information can be weighted to provide further decision support (e.g., accurate, current and relevant) for the clinician. While several parameters are illustrated in FIG. 2 as being analyzed and weighted, other parameters may be substituted therefor and/or added thereto, as would be understood by one skilled in the art, without departing from the scope of the inventive concept.

FIG. 3 illustrates another example process. In item 301, active problem concerns are evaluated. For example, but not by way of limitation, the active problem concerns may be evaluated against a set of medical parameters. The set of medical parameters may include, but is not limited to, medications, duration of problem concern, and patient data. Depending on processing and/or storage capacity requirements, the number of parameters may be adjusted upward or downward. Moreover, the clinician may selectively choose parameters, depending on the subjective judgment of the situation. The evaluation of the medical parameters thus generates an evaluation result for each of the parameters.

In item 302, the evaluation results for each of the parameters indicative of a problem concerns are used to determine whether to move a problem concern from an active state to a past state. This selection can be based on criteria that is determined based on a well-known record (e.g., maximum duration of a problem concern has passed, and thus the problem concern is moved to the past problem concern section). In item 303, the problem concerns that are determined to not be active problem concerns are moved to past problem concerns. Optionally, a clinician may attach a degree of confidence to the determination for the moved active problem concerns. For example, a clinician may attach a lower degree of confidence for a medication which the user has not taken, if the user has a history of not taking medication that has been prescribed, particularly with respect to a chronic problem concern.

In item 304, the past problem concerns, including those that were moved in item 303, are evaluated. For example, the past problem concerns may be weighted or otherwise scored or ranked with respect to their characteristics, such as (but not limited to) frequency, duration, seriousness, or connectedness. In other words, the frequency and seriousness are checked by a checker and the connectedness is determined by a determiner.

In item 305, a determination is made as which of the past problem concerns are to be displayed by a display device. The past problem concerns to be displayed may include those problem concerns having a higher ranking or weighting, i.e., those that would be more relevant to the clinician.

In item 306, the active problem concerns are displayed in a first portion of a summary screen, and the selected past problem concerns are displayed in a second portion of the summary screen. Thus, all of the active problem concerns that were not moved to past problem concerns, as well as the past problem concerns that have been selected, are displayed.

While the foregoing example embodiments disclose healthcare record management, the present inventive concept is not limited thereto. For example, the inventive concept may be applied to fields other than healthcare record management, as would be understood by those skilled in the art.

FIG. 4 is a block diagram that illustrates an example embodiment of a computer/server system 400 upon which an example embodiment may be implemented. The hardware system 400 includes a computer/server platform 401 including a processor 402 and memory 403 which operate to execute instructions, as known to one of skill in the art. The term “computer-readable medium” as used herein refers to any medium that participates in providing instructions to processor 502 for execution. Modules or software described throughout the specification may also be executed by the processor 402. Additionally, the computer platform 401 receives input from a plurality of input devices 404, such as a keyboard, mouse, touch device or verbal command.

The computer platform 401 may additionally be connected to a removable storage device 405, such as a portable hard drive, optical media (CD or DVD), disk media or any other medium from which a computer can read executable code. The computer platform may further be connected to network resources 406 which connect to the Internet or other components of a local public or private network. The network resources 406 may provide instructions and data to the computer platform from a remote location on a network 407. The connections to the network resources 406 may be via wireless protocols, such as e.g., the 802.11 standards or cellular protocols, or via physical transmission media, such as cables or fiber optics. The network resources may include storage devices for storing data and executable instructions at a location separate from the computer platform 401. The computer interacts with a display 408 to output data and other information to a user, as well as to request additional instructions and input from the user. The display 408 may therefore further act as an input device 404 for interacting with a user.

For example, but not by way of limitation, the computer platform 401 may change an active/past state of the data from an active state to a past state based on a time of an update (e.g., time of an update of a diagnosis, when a file may be updated) indicative of a resolution of the problem concern, and when a most recent entry in the data exceeds a duration range for the problem concern as determined by a knowledge base, changes the active/past state of the data from the active state to the past state. The computer platform 401 determines whether the problem concern is correlated with a treatment, and when the correlated treatment is being taken by a subject, changes the active/past state of the data from the active state to the past state.

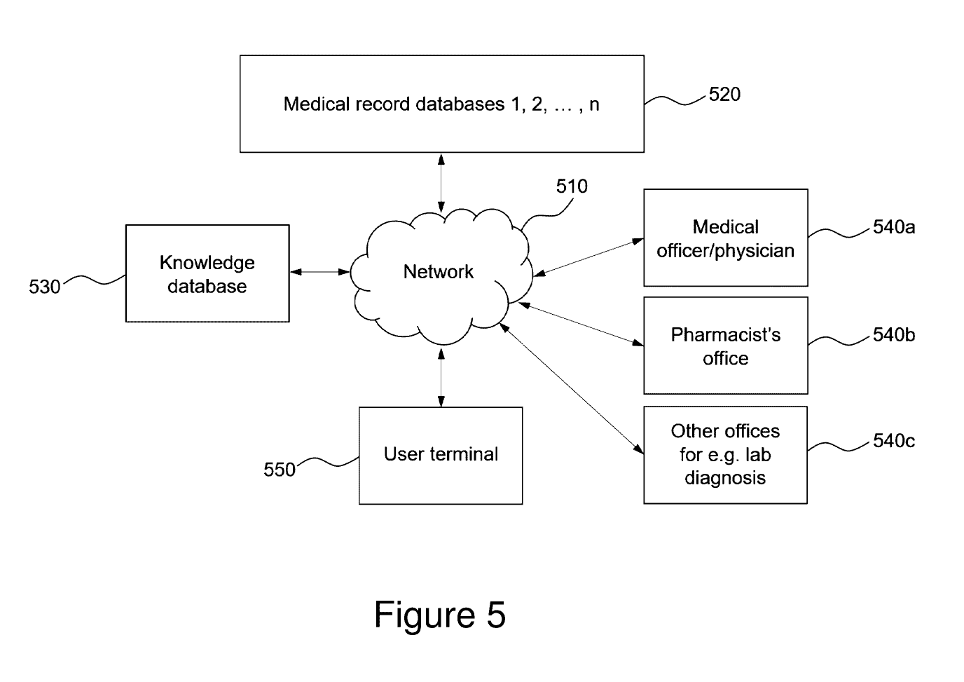

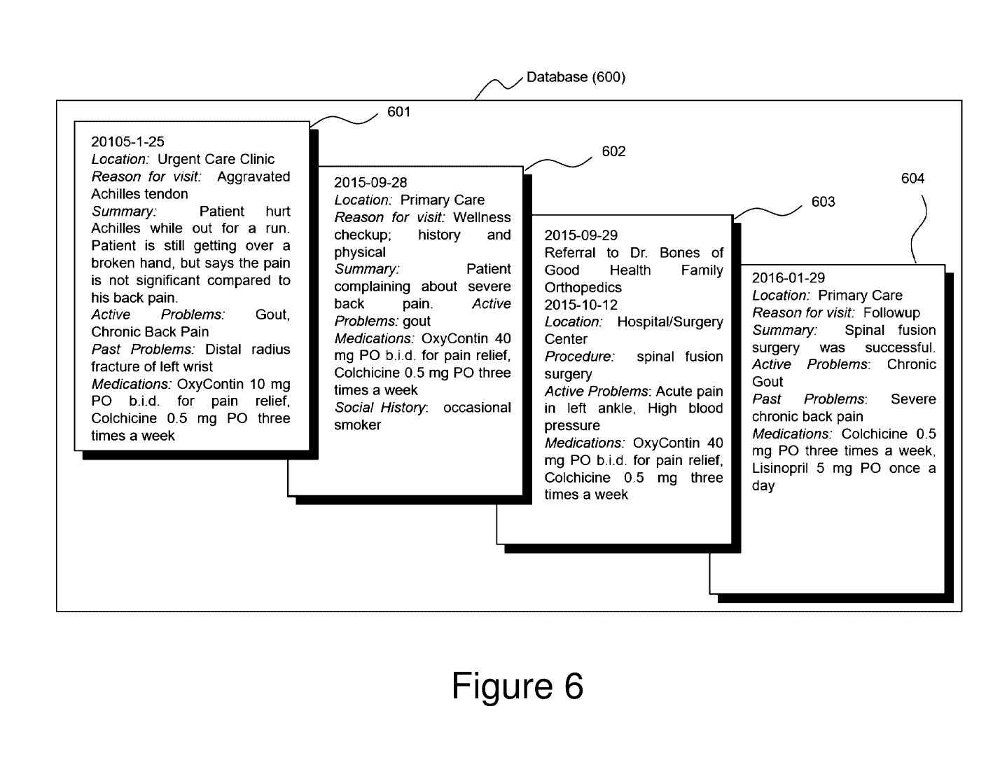

In a further example embodiment, to demonstrate the concept, an example is adopted. For example, consider a processing network environment having network 510 in FIG. 5 for processing medical records 601-604 in the database 600 shown in FIG. 6 of a hypothetical patient John Doe who moved to an area a couple of years ago. In FIG. 6, John has many additional medical records 601-604 from the previous medical providers (such as different physicians in different clinics/hospitals) in medical database 600. Presently, John appears on the schedule for his primary care physician. The present invention in e.g. FIGS. 2 and 5 can accurately output the treatment of an active problem concern or a past problem concern that is chronic and based on determined connectedness between the present problem concern and the active problem concern or the chronic past problem concern, diagnostic assistant information such as treatment for the present problem concern can be provided to the physician. For example, assuming the scheduled visit of John is just a normal checkup, i.e. the computer platform 401 aggregates a list of active problem concerns from the medical record and normalize to SNOMED CT (note the last medical record on which it was listed as “Active”) such as gout (chronic gout) in Jan. 29, 2016, chronic back pain in Oct. 12, 2015, hypertension in Sep. 28, 2015, and aggravated Achilles tendon in Jan. 25, 2015. After that, the system will have a list of Active and Past problem Concerns across all of the different medical documents in the record:

### Active Problem Concerns:

Gout (2015 Jan. 25)

Chronic Back Pain

Gout (2015 Sep. 28)

Acute pain in left ankle

High blood pressure

Chronic Gout (2016 Jan. 9)

### Past Problem Concerns:

Distal radius fracture of left wrist

Severe Chronic Back Pain (2016 Jan. 9)

Through normalization to SNOMED CT, the active problem concern list is collapsed in order to avoid repeating the same problem concerns multiple times. For example, even though 2 records say “Gout” and the other says “Chronic Gout”, the “Chronic gout without tophus” concept is a child of the “Gout” concept and so these problem concerns may be merged together. The exact threshold for such merging can be configured.

Processing loop is set to check all the active problem concerns in record. In this loop, the system will score each of the active problem concerns. The computer platform 401 determines if the medical record contains evidence of problem resolution of problem concerns such as gout (chronic gout) with entry appears on most recent summary with no sign of being resolved is listed as Active Problem Concern, chronic back pain being resolved is listed as a Past (or inactive) Problem Concern. For example, aggravated Achilles tendon with “no lingering pain” in unstructured note on Sep. 28, 2015 is put into the Past Problem Concern list, and similar situation applies to hypertension which is not mentioned in any document after Sep. 28, 2015 and is put into the Past Problem Concern list, e.g. gout, a chronic problem concern, and (Colchicine) is present in latest record, chronic back pain has hypertension (Lisinopril) listed in the latest record, aggravated Achilles tendon is not listed.

The duration of the problem concern is compared with the expected or average duration, if the duration is longer than the expected duration, the problem concern is treated as resolved or inactive and is put into the Past Problem Concern list, and problem concern/problem concern that has no expected end time remains an Active Problem Concern, for example, gout (chronic gout) is indicated as chronic problem concern with no expected end date, hypertension is indicated as chronic problem concern with no expected end date. Other problem concerns have an end time such as aggravated Achilles tendon has average recovery time of 6 weeks.

The medication records are checked for correlation with each problem concern. For example, the medication Colchicine is present in latest record and this is a drug that is indicated for chronic gout. Similarly, Lisinopril is indicated for hypertension. Based on the presence of these medications, both Gout and Hypertension should be kept in the active problem concerns list.

In one embodiment, each step is used to populate a feature score (instead of a yes/no decision), where the feature score is based on the computed ‘strength of evidence’ for each metric.

For example, to populate each metric with a value from 1-3, we can use the following chart:

| | 1 | 2 | 3 |
|---|---|---|---|
| Inverse | Direct evidence | No evidence about | Direct evidence |
| Problem | that the problem | the current state of | that the problem |
| Resolution | concern is | the problem concern | concern is still |
| Evidence | resolved | | active |
| Expected | Based on the | Based on the | Based on the |
| Duration | expected duration, | expected duration, | expected duration, |
| Evidence | the problem | the problem concern | the problem |
| | concern was | was expected to | concern is |
| | expected to be | be resolved within | expected to be |
| | resolved >30 days | 30 days of the date | ongoing |
| | prior to the date | of summarization | |
| | of summarization | | |
| Medication | No active | Active medications | Active medications |
| Evidence | medications that | that may be | that are highly |
| | are associated with | associated with this | associated with |
| | treatment of this | problem concern | the treatment of |
| | problem concern | (e.g. pain medication, | this problem |
| | | off-label use, etc.) | concern (e.g. drugs |
| | | | that are indicated |
| | | | for this problem |
| | | | concern) |

Applying this chart to the sample above, we combine the scores into a composite score that indicates the Likeliness to be Active for each problem concern entry. In one realization, the composition algorithm is a simple summation of all the different scoring features and the threshold is configured to be a score of ‘6’.

| | Inverse | | | |
|---|---|---|---|---|
| | Problem | Expected | | |
| | Resolution | Duration | Medication | Likeliness |
| | Evidence | Evidence | Evidence | to be |
| | (1-3) | (1-3) | (1-3) | Active |
| Gout | 3 | 3 | 3 | 9 |
| Chronic back pain | 1 | 3 | 1 | 5 |
| Hypertension | 2 | 3 | 3 | 8 |
| Aggravated | 1 | 1 | 1 | 3 |
| Achilles tendon | | | | |
| . . . | | | | |

For problem concerns that were listed as ‘Active’ having a high degree of confidence that the problem concern is no longer active, combine them with the entries on the Past Problem Concerns list (also normalized to SNOMED CT), for example, the problem concerns of open fracture of left radius Jan. 25, 2015, and chronic back pain (Severe chronic back pain) Jan. 29, 2016. For all the concerns, a likeliness score of relevance is determined based on all the above scores of Inverse Problem Resolution Evidence, Expected Duration Evidence, and Medication Evidence, and in case the likeliness score of relevance is above some configurable threshold, the condition or problem concern of this likeliness score of relevance is included in the summary displayed in a display device. In one example embodiment, the system is configured to select the top X concerns (e.g. no more than 5) or to look for natural ‘jumps’ that are near this threshold (e.g. to avoid #6 being removed from the list if the likeliness score of relevance was almost equivalent). In this example, we select anything above 15, meaning that Gout and Hypertension will be included as Active Problem Concerns on the summary.

Then, for the past problem concern list, frequency, seriousness, and connectedness scores are computed for each of the past problem concerns. For example: Open fracture of left radius appears only in the document from Jan. 25, 2015, whereas chronic back pain (severe chronic back pain) appears in numerous documents, etc. In a naïve implementation, the frequency score can be set to the number of medical records which contain this concept.

Open fracture of left radius has no further information but chronic back pain (severe chronic back pain) is listed as “severe”. In a naïve implementation, the severity score can be tied to the modifiers that appear before the given concept:

Mild/moderate 1

No modifier 2

Severe/critical 3

On a hypothetically pre-computed knowledge graph, open fracture of left radius is related to chronic back pain, gout, and broken wrist via the symptom of ‘pain’ (e.g. open fracture of left radius—has symptom-->pain—is symptom of-->chronic back pain). One measure of connectedness is the fewest number of edges between any two concepts on the graph, although many other measures of connectedness can be computed from this graph representation as well. A score of likeliness is resulted based on all the above scores of Frequency, Seriousness, and Connectedness. For example, the above processes may result in the following summary.

| | | | Connectedness | |
|---|---|---|---|---|
| | | | (minimum | |
| | | | number of | Likeliness |
| | Frequency | Seriousness | edges between | to be |
| | (count) | (1-3) | concepts) | Relevant |
| Open fracture of | 1 | 1 | 2 | 4 |
| left radius | | | | |
| Chronic back pain | 2 | 3 | 2 | 7 |
| . . . | | | | |

If no other ‘past problem concerns’ exist with a higher likeliness to be relevant score or relevance score, these values may be included in the summary under the Past Problem Concerns section. Treatment information of past problem concerns with high connectedness with the active problem concerns are also listed in the summary instead of being ignored due to its ‘past’ state of problem concern, and the helpful treatment information highly related to the active problem concern is also exposed. In other words, the system can accurately provide a treatment information of a problem concern based on a determined connectedness with the present problem concern or active problem concerns. The summary of both lists of active problem concerns and past problem concerns with high connectedness is displayed by a display device. For example, if the reason for visit was known in advance (via registration/scheduling/patient intake) to be about patient-reported hand stiffness, this would affect the ‘connectedness’ scoring of the prior broken wrist, greatly improving the chances of it being included in the summary. The input, output, and data processing of any of the above processes may be carried out by IBM Natural Language Processing (NLP) which works at linguistics level that provides a much greater understanding of the text being analyzed, that is, the NLP engine understands the language that is being parsed and determines the parts of speech, understands the word, and sentence structure of the language being analyzed.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an example embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A non-transitory computer readable medium configured to store instructions creating a patient's medical summary, the instructions causing a computer to:
receive at least one medical record from at least one database;
parse the received at least one electronic medical record;
identify at least one medical problem concern in the medical record based on the parsing;
determine, for each of the at least one medical record, if the respective problem concern is resolved or is ongoing based on information in the parsed electronic medical record; and
in response to the determining that the respective problem concern is resolved, label the respective problem concern as past problem concern,
wherein the determining that the respective problem concern is resolved comprises:
(1) determine if the problem concern is terminated based on the information in the parsed electronic medical record,
(2) determine dates in the information in the parsed electronic medical record and compare to a threshold and if the comparison yields that the dates are above the threshold, an expected duration of the problem concern is passed,
(3) determine if the respective problem concern is not mentioned in subsequent electronic medical records such that the respective problem concern is no longer being treated, and
if determination of (1), (2) and (3) yields yes, label the problem concern as past problem concern and output the labeled past problem concern.

2. The non-transitory computer-readable medium of claim 1, wherein the information indicating that the problem concern is no longer being treated is a medication information.

3. The non-transitory computer-readable medium of claim 1, wherein the identifying is based on a confidence level of the information in the parsed electronic medical record.

4. The non-transitory computer-readable medium of claim 1, wherein the instructions further cause the computer to weight the past problem concern based on at least one of frequency, duration, seriousness, and connectedness of the past problem concern with respect to other problem concerns in the patient's at least one electronic medical record.

5. The non-transitory computer-readable medium of claim 4, wherein the instructions further cause the computer to compare the weighted past problem concern with a threshold level.

6. The non-transitory computer-readable medium of claim 1, wherein the patient electronic medical records are produced using a clinical knowledge base.

7. The non-transitory computer-readable medium of claim 1, wherein the problem concern is formed by grouping a plurality of similar problem concerns.

8. The non-transitory computer-readable medium of claim 1, wherein the medical problem concern in the at least one medical record of the patient is provided by using at least one of terminology of Systemized Nomenclature of Medicine and International Classification of Diseases.

9. The non-transitory computer-readable medium of claim 1, wherein the patient having the past problem concern is currently being cured or having a dormant medical condition that a treatment is no longer required at a present time.

10. The non-transitory computer-readable medium of claim 1, wherein the instructions further cause the computer to:
determine active problem concerns;
aggregate the active problem concerns from the patient's at least one medical record;
search from the patient's at least one medical records for evidence of resolution of the aggregated active problem concerns; and
query the active problem concerns based on expected durations or average durations of the active problem concerns.

11. The non-transitory computer-readable medium of claim 5, wherein the instructions further cause the computer to:
display the identified and weighted past problem concern in response to determining that the weighted past problem concern exceeds the threshold level; a physician determines that the patient does not require an immediate attention from the physician based on the displayed past problem concern.

12. An apparatus creating patient medical summary, the apparatus comprising:
a processor configured to determine a medical problem concern in a patient's medical records comprising information indicating at least one of: the problem concern was terminated, an expected duration of the problem concern was passed, and the problem concern was no longer being treated; and
a memory,
wherein the processor identifies the problem concern as a past problem concern in response to the determining indicating that one of the medical records contains the information indicating said at least one of: the problem concern is terminated, an expected duration of the problem concern is passed, and the problem concern is no longer being treated, and
wherein the processor displays the identified past problem concern on a display such that a physician determines that the patient does not require an immediate attention from the physician based on the displayed past problem concern.

13. The apparatus of claim 12, wherein the information indicating that the problem concern is no longer being treated is a medication information.

14. The apparatus of claim 12, wherein the identifying is based on a confidence level of the information.

15. The apparatus of claim 12, wherein the processor further weights the past problem concern based on at least one of frequency, duration, seriousness, and connectedness of the problem concern to other problem concerns in the patient's medical records.

16. The apparatus of claim 15, wherein the processor further compares the weighted past problem concern with a threshold level and displays the weighted past problem concern in response to determining that the weighted past problem concern exceeds the threshold level.

17. The apparatus of claim 12, wherein the patient medical records are produced using a clinical knowledge base.

18. The non-transitory computer-readable medium of claim 12, wherein the problem concern is formed by grouping a plurality of similar problem concerns.
